(19) United States
(12) Patent Application Publication
(10) Pub. No.: US 2013/0297363 A1
(43) Pub. Date: Nov. 7, 2013

(54) ALIGNMENT OF OPERATIONAL READINESS ACTIVITIES

(71) Applicants: James S. Leitch, Aliso Viejo, AZ (US); James B. Humphries, Greenville, SC (US)

(72) Inventors: James S. Leitch, Aliso Viejo, AZ (US); James B. Humphries, Greenville, SC (US)

(21) Appl. No.: 13/695,941

(22) PCT Filed: May 3, 2011
(86) PCT No.: PCT/US11/34926

§ 371 Date: Feb. 15, 2013

Related U.S. Application Data
(60) Provisional application No. 61/330,701, filed on May 3, 2010.

(30) Foreign Application Priority Data
May 3, 2010 (US) 61330701

(51) Int. Cl. G06Q 10/06

(52) U.S. Cl. CPC G06Q 10/063112
USPC 705/7.14

(57) ABSTRACT

An operational readiness alignment system is presented. A planning engine leverages readiness activities previous projects to determine which readiness activities are relevant to a current project. The planning engine can further correlate readiness activities with available team members to derive a responsibility matrix representing a recommendation on which team members should be assigned to which readiness activity roles or responsibilities. One can use the contemplated system to derive one or more readiness measures.

This application claims the benefit of priority to U.S. provisional application 61/330,701 filed May 3, 2011. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is operational readiness technologies.

### BACKGROUND

Individual team members (e.g., owners, EPC contractors, suppliers, licensors, stakeholders, etc.) involved with a new plant or facility project come from many different, independent corporate entities or affiliations. Unfortunately, a new plant owner often finds aligning work processes across the team members to be quite difficult. One reason for the difficulty is the plant owner or other stakeholders lack prior knowledge, experience or current visibility into readiness requirements, or skills of each team member. An additional reason is that corporate entities or individual team members each lack experience across all disciplines, roles, responsibilities, or activities required for the plant engineering, procurement, construction, commissioning operations and maintenance (EPCCOM) of the plant. For example, the plant owner, the owner's employees, or contractors engaged by the owner, likely lack experience in identifying the work which needs to be completed at each phase of a project, or don't know how to align the parties or their relative responsibilities. Typically, there are thousands of activities that need to be identified, planned, prioritized, assigned, performed, or completed, well beyond the scope of just a plant owner.

Ideally, plant owners could leverage previous experiences from other entities that have been involved with hundreds or thousands of construction projects, FLUOR® Corporation for example. The experiences of one or more EPCCOM companies can be folded into a system or methods to aid the plant owner to align activities across all team members. For example, an alignment readiness system could include a knowledge-base housing the stored experiences from previous project in the form of templates, checklists, activity deliverable descriptions, responsibility matrices, or other types of readiness activity items. These together can be used to identify and gain alignment on the appropriate operational readiness activities or requirements for the new plant. The collective knowledge across many projects can be brought to bare to determine which individuals can be assigned to activities.

Examples of previous efforts applied toward project management techniques include the following references:

U.S. patent application publication 2008/0270205 to Kumar et al. titled “Program Management Systems and Method Thereof”, filed Nov. 21, 2007, discusses managing a lifecycle program in an organization via one or more management modules.

U.S. patent application publication 2009/0018886 to Lacy et al. titled “Web-Base System and Application for Collaborative Planning of a Networked Program Schedule”, filed Jul. 9, 2007, describes a web based system to allow individuals to work together on a program; from planning stages through feedback into future programs.

International patent application publication WO 01/08037 to Greenberg et al. titled “A System, Method and Article of Manufacture for Determining Capability Levels of Processes for Process Assessment Purposes in an Operational Maturity Investigation”, filed Jul. 26, 2000, mainly describes measuring a maturity level of a company and references planning for site construction.

U.S. patent application publication 2008/0183532 to Barnard et al. titled “Method for Project Preparing a Procurement and Accounts Payable System”, filed Apr. 2, 2008, discusses a project manager has the task of assessing readiness with respect to a project. Interestingly, Barnard merely contemplates assigning resources to task, but fails to appreciate the resources can be assigned to an actual readiness activity to achieve readiness.

In a similar vein, U.S. patent application publication 2005/0114829 to Robin et al. titled “Facilitating The Process of Designing and Developing a Project”, filed Sep. 30, 2004, mainly focuses on developing a software project as opposed to large scale construction project. Robin discusses that team members of a software project should be in a state of readiness for their assigned roles. However, Robin fails to appreciate that a project planning engine can leveraged previous project information to construct recommendations on which individuals can be assigned to operational readiness activities to ensure readiness.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

What has yet to be appreciated is an operational readiness alignment system can be developed capable of housing vast amounts of knowledge relating to known readiness activities from previous projects that have successfully achieved operation readiness for a plant. The readiness activities can be stored in a knowledge-base as items (e.g., data objects). The known activities can be correlated with a current project to identify a fit-for-purpose scope deliverable responsibility planning solution for the new plant owner. As a project is undertaken, the experiences gained on the current project can be fed back into the knowledge-base to be applied to future projects. One results of such an alignment system can include a responsibility matrix representing a recommendation of team members that can be assigned to readiness activities.

Thus, there is still a need for improved operational readiness alignment systems.

### SUMMARY OF THE INVENTION

The inventive subject matter provides apparatus, systems and methods in which enables EPCCOM project team members to leverage previous experiences to align activities for operational readiness of a plant or facility. One aspect of the inventive subject matter includes an operational readiness alignment system. One or more knowledge-bases can be provided that store or record various items relating to known readiness activities, preferably related to previous plant construction projects. Each of the readiness activity items can be stored as a distinct, manageable object having attributes or characteristics. In addition, a team member database can provide for storing of information relating to the project team members, including their capabilities or areas of expertise. One should note that the team member database can comprise information about team members spanning across multiple organizations, corporate entities, affiliations, or other boundaries.

In more preferred embodiments, a planning engine can be coupled to the knowledge-base and team member database. The planning engine can be configured to obtain information from the data stores and analyze the information with respect to a current project. For example, the planning engine can be configured to derive a set of relevant readiness activities based on known activity items stored in the knowledge-base and based on information relating to a current project. Furthermore, the planning engine can generate a responsibility matrix that aligns team members with the relevant readiness activities as a function of the team member's capabilities. In some embodiments the matrix represents one or more recommendations for team member assignments on a role-by-role basis. It is also contemplated that the recommended team member assignments can be ranked according to one or more metrics (e.g., primary responsibility vs. support responsibility, possibly according to degree of match between a member's capabilities and attributes of relevant activities, etc.).

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of an operational readiness activity system.

FIG. 2 is a possible responsibility matrix.

### DETAILED DESCRIPTION

It should be noted that while the following description is drawn to a computer/server based readiness systems, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including an infrastructure capable instructing remote devices, possibly a project interface, to render a responsibility matrix as a recommendation of team members that can, or should, be assigned to readiness activities.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Operational readiness can be considered a measure of how well a new plant owner is prepared to take over a new plant or facility. A readiness activity represents actions that should be taken to close a gap between a current state of preparedness and an acceptable state of taking over operation of the facility. One should appreciate the distinction between merely assessing readiness and taking action to create or increase readiness. Readiness activities are the latter rather than the former.

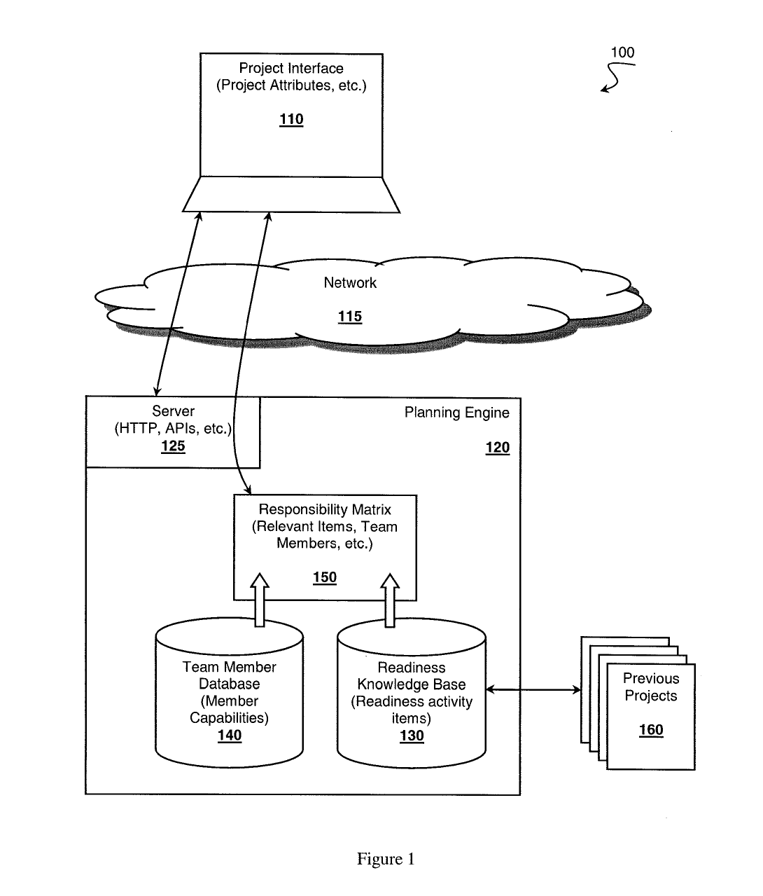

FIG. 1 provides an overview of operational readiness alignment system 100 where a planning engine 120 can access one or more databases. In the example shown, the planning engine has access to readiness knowledge-base 130 and team member database 140. Users interfacing with planning engine 120 for a current project can utilize project interface 110, through which planning engine 120 electronically receives project attributes of the current object, possibly through a web browser.

Readiness knowledge-base 130 stores readiness activity items as data objects, where each item relates to known readiness activities, documents, deliverables, or other items. Readiness items can include templates, checklists, documents, deliverable lists, deliverable or activity descriptions, specifications, or any other item that can reflect previous experiences obtained from by previous projects 160. Each item can be stored as a data object having one or more attributes, possibly as metadata, which describes or defines how the item relates to operational readiness. Example attributes can include required skills, certifications, locations, languages, or other properties describing the item.

As discussed above, readiness activity items can take on many different forms. Even though the items can be different types of objects (e.g., documents, checklists, defined activities, etc.), one should note that each item, at a very basic level, is considered to represent a readiness activity regardless of the type of object. For example, a checklist requires an individual to take on the responsibility of completing the checklist. A document or memo requires an individual to take on the responsibility of reading, updating, reviewing, or interacting with the document. Thus one or more individuals can be assigned responsibility for handling the actions associated with an activity item. Even a responsibility matrix outlining an operational readiness alignment from previous projects can require an individual to take on the responsibility of aligning the matrix to a current project. In some embodiments, the responsibility can be fulfilled at least partially by the planning engine.

Readiness activity items are preferably stored according to a project agnostic format, possibly based on an XML-based schema, to allow for converting the items into a project specific format. For example, a checklist can include generic checklist items reflecting inspection points, or other items of interest, that should be in place for a plant to achieve operational readiness. The checklist can include one or more project agnostic metadata descriptions for each checklist item. When the checklist is converted for use according to a specific project, the descriptions can be localized to a specific jurisdiction. In some embodiments, attributes codes or other data can translated from the generic project agnostic format to a language corresponding to the language used within the jurisdiction of the plant or even targeting a preferred language of an assigned team member.

In some embodiments, each readiness activity item can contribute to a readiness measure indicating preparedness of a new plant owner's ability to take over operation of a plant. The contribution from each readiness activity item can correspond to how the item contributed to previous projects 160 with respect to operational readiness. The contribution can be normalized as desired based on a number of relevant activity items to a current project of interest, or by weighting an item based on previous contribution to other projects 160.

New readiness activity items can be obtained through project interface 110. It is expected that known readiness activity items might lack coverage across a new project due to changes in jurisdictional requirements, changes in laws, or new requirements. A team member can utilize project interface 110 to create, or otherwise manage, readiness activity items and store the readiness activity items within knowledge-base 130. As the current project achieves readiness, feedback of the effectiveness of the utilized relevant readiness activity items can be stored back into the knowledge-base 130. The effectiveness can be measured through post mortem analysis or through ratings assigned by involved team members, include plant owners.

Team member database 140 can store information relating to team members, including team member capabilities. One should note that the team member information could be pre-existing information or could include newly stored information, possibly entered or provided by a plant owner, or other entity involved with eh project via project interface 110. In more preferred embodiments, the team member information comprises information relating to the capabilities of the team member where the capabilities also relate to operational readiness. For example, capabilities are contemplated to include various attributes that can affect a team member's ability to execute a readiness activity. Contemplated capabilities could include experience, skills, language, location, preferences, affiliation, or other factors that can be useful in making a determination if a team member has the required capability, capacity, or experience, thus could match with or be assigned to an activity.

Contemplated construction projects can include globe spanning construction projects having involvement of multiple large multi-national firms, impacted by geo-political boundaries, or even affecting economies. Given the global nature of such projects, one should appreciate that team member database 140 also stores affiliation attributes of team members. Affiliation attributes can indicate with which entity a team member is associated. Example affiliation attributes can represent one or more independent corporate entities, citizenship, religious alignment, or other affiliations. Such information is consider advantageous when determining which team member would likely best align with an activity especially when the activity takes place in a specific country or involves other team members have similar affiliations.

As with activity item attributes, the team member capability attributes can also be stored in a project agnostic format. In more preferred embodiments, the capability attributes and the activity items are aligned according to one or more common, intermediary namespaces allowing quick correlation between activity items and team members. For example, an activity item representing inspection of welding points would likely have a number of attributes that have values within the namespace describing the item. Examples within a hierarchal namespace could include the following:

activity_item.name = “Welding Inspections”
activity_item.tag = weld
activity_item.tag = inspection
activity_item.experience = 5 years
activity_item.deliverable = report
activity_item.role.deliverable = NULL
activity_item.role.guide = NULL
activity_item.role.work = NULL

Although the above example is very simple, one should appreciate the attribute namespace and associated attribute values can be quite complex involving many different attributes or even multi-valued (e.g., vector, matrix, data structures, etc.) attributes values. When correlating team members with activity items, team member attributes can be directly compared to the activity items attributes to determine if the two data objects can be linked. Note that some of the attributes have values of NULL indicating they have yet to be assigned values. In this example, the attributes represent roles or responsibilities that will take on values when a team member is assigned to the role or responsibility.

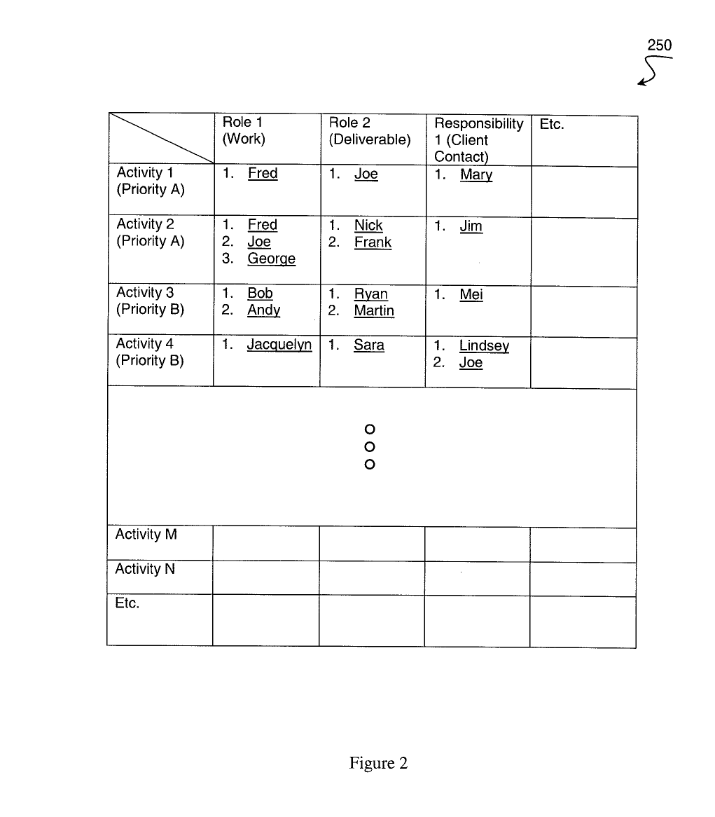

In view that readiness activity items and team members can have multiple attributes that might or might not have significant overlap, one team member might have a stronger correlation to a readiness activity item, or it's constituent, relative to other team members. In such scenarios, the extent of a team member's attribute overlap with a readiness activity item's can be utilized to rank team members as discussed below with respect to FIG. 2.

Current project information can be gained or supplied to planning engine 120 through various means including through project interface 110 over network 115 (e.g., LAN, WAN, Internet, etc.). For example, a plant owner can provide information relating to their known readiness activities, expected deliverables, or team member information. It is expected that readiness knowledge-base 130 can also include a priori defined information, possibly from an EPC construction firm having experience from hundreds or even thousands of previous projects. In some embodiments, an EPC construction firm can work with a plant owner to obtain current project information by facilitating scope or planning workshops. One should note there are thousands of activities or deliverables which need to be reviewed and a determination made whether they are relevant to the client's planned project thus creating a strong pull for identifying relevant readiness activity items by correlating activity item attributes of known readiness activity items with project attributes of the current project.

Various readiness activity items can be leveraged from readiness knowledge-base 130 during the process of obtaining current project information or project attributes via project interface 110. Examples of readiness items that are considered useful during planning stages include various documents identifying a purpose, scope, or deliverables list; preferred project phasing templates; scope deliverable responsibility matrices; or other items. It is contemplated that the readiness alignment system can include one or more computer interfaces through which information can be exchanged with the plant owner as represented by project interface 110. The computer interface could include an Application Programming Interface (API), web service, web page, software application, or other type of interface. Use of a readiness alignment system early in project planning aids in educating the plant owner, or other project team members, on operation readiness requirements.

Planning engine 120 represents one or more computing systems operating to align readiness activities with team members to ensure that a current project achieves operational readiness. As illustrated, planning engine 120 interface with project interface 110 via server 120, an HTTP server for example. Planning engine 120 couples with readiness knowledge-base 130 and team member database 140 and is preferably configured to identify relevant readiness from knowledge-base 130 that are considered applicable to a current project. In addition, planning engine 120 preferably generates a responsibility matrix indicating a recommendation of which team members from team member database 140 can be assigned to actions associated with the relevant readiness items.

Planning engine 120 can be used to compare the current project information with known readiness activity items. In some embodiments, the planning engine can compare attributes associated with the activity items to attributes of the current project obtained via project interface 110 to determine if there is a match or near match. The result of the comparison can yield one or more items representing activities that are considered relevant to the current project. Furthermore, planning engine 120 can also determine the roles or responsibilities for planning or completing the relevant activities or deliverables. Each activity or deliverable of a readiness activity item can be assigned to a responsible team member. During assignments, role of the team members can be specified as a deliverable-centric role (e.g., prime responsibility to complete the activity or deliverable), a guide-facilitate role (e.g., coaching, technical support, and providing assistance), or as not relevant (e.g., no role).

Based on assignments, planning engine 120 generates responsibility matrix 150 representing how team members could be aligned with various relevant readiness activities (e.g., roles, responsibilities, actions, etc.). It should be appreciated that matrix 150 can take the form of a recommended alignment where multiple team members could be assigned to the same activity or role. In such an embodiment, the matrix can provide a relative ranking of team members on an activity-by-activity basis, role-by-role basis, or other arrangement. Ranking team members can be conducted according to any desired criteria including degree of match between team member capabilities and activity item attributes, experience, location, or other properties.

FIG. 2 presents example responsibility matrix 250. The planning engine can configure one or more project interfaces to render responsibility matrix 250 to users of the system. For example, responsibility matrix 250 can be presented within web browser where each element of matrix 250 can include hyperlinks allowing a user to drill down on content that contributed to the recommended alignment.

Responsibility matrix 250 is illustrated as a 2-dimensional matrix of activities versus roles or responsibilities. Each element of metric 250 indicates one or more team members considered to represent recommendations for the activity. Recommended roles can include deliverable-centric role, guide-facilitating role, or even no role. When multiple team members are recommended for a role or responsibility (e.g., deliverable, work, etc.), the team members can be ranked according to one or more metrics. As discussed previously, the ranking can be derived from the extent of overlap between a team member's capabilities attributes and an activities attributes (e.g., by number, by weighting, by experience, by assigned ratings from others, etc.). For example, Activity 2 and Role 1 lists three team members where Fred is the most recommended team member.

Responsibility matrix 250 can comprise a prioritization of the relevant readiness activities for the current project. In the example shown, higher priority activities are listed first in matrix 250 while lower priorities are listed later. Prioritization can be based on an impact that an activity had on achieving readiness on previous projects. The impact can be quantized by the number of times the activity played a role within the previous projects or even based on ratings established obtained from team members of previous projects during corresponding post mortem analysis.

Although responsibility matrix is presented as a 2-dimensional matrix, one should appreciate that contemplated responsibility matrix could have high dimensionality. For example, phases (e.g., design, engineering, construction, etc.) of the current project could represent a third dimension of matrix 250. In fact, one could include additional dimensions possibly based on engineering, procurement, construction, commissioning operations or maintenance. For example, an activity might include a re-occurring activity that must be performed at each phase of the project to achieve readiness.

Responsibility matrix 250 can further comprise a readiness measure representing a preparedness of the new plant owner of taking operational control of the plant. The measure can include one or more values. One contemplated value includes a predicted readiness measure indicating a likelihood of preparedness if all readiness activities and assigned team members are accepted or executed. The predicted readiness measure could be represented as a percentage or probability. In some scenarios the predicated measure is likely to be less than 100% simply because insufficient team members or team members lacking proper capabilities are present. Another example of a readiness measure can include a current readiness measure based on completed activities.

The disclosed approach provides additional benefits. One benefit includes the ability to differentiate between who is responsible for performing work (e.g., Role 1) and who is responsible providing deliverables (e.g., Role 2) for a single activity. Another benefit is that system can be used to tailor operational readiness activities to a client's project to provide a fit-for-purpose scope deliverable responsibility planning solution.

The disclosed techniques are also considered to apply beyond plant construction projects. Other markets that could benefit from the inventive subject matter include software development, social program development, heath care management projects, or other industries where individuals across many corporate environments are to work together to achieve a common goal.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An operational readiness alignment system comprising:
a readiness knowledge-base storing known readiness activity items related to previous projects, the activity items comprising activity attributes;
a team member database storing member information, including team member capabilities;
a project interface configured to electronically receive project attributes of a current project; and
a planning engine coupled with the readiness knowledge-base, the team member database, and the project interface via communication links, and is configured to:
identify relevant readiness activity items by correlating activity item attributes of the known readiness activity items with the project attributes of the current project;
generate a responsibility matrix indicating a recommendation of which team members can be assigned to the relevant readiness activity items by correlating the team member capabilities with the activity attributes associated with the relevant readiness activity items corresponding to the relevant activities; and
configure the project interface to present the responsibility matrix.

2. The system of claim 1, wherein the responsibility matrix comprises a recommended role for an assigned team member.

3. The system of claim 2, wherein the recommended role comprises a deliverable-centric role.

4. The system of claim 2, wherein the recommended role comprises a guide-facilitating role.

5. The system of claim 2, wherein the recommended role comprises no role.

6. The system of claim 1, wherein responsibility matrix comprises at least one of the relevant readiness activity items has multiple recommended team members.

7. The system of claim 6, wherein the responsibility matrix comprises a ranked listing of the recommended team members associated with the at least one of the relevant readiness activity items.

8. The system of claim 6, wherein the responsibility matrix comprises a differentiation between at least two of the recommended team members according to who is responsible for working on an activity of one of the relevant readiness activity items and who is responsible for providing a deliverable of the same one of the relevant readiness activity items.

9. The system of claim 1, wherein the readiness activity items comprise at least one of the following: a template, a checklist, a resource list, an activity list, an activity description, a deliverable list, a deliverable description, a precedence relationship list, and preferred phase list.

10. The system of claim 1, wherein the project interface is configured to receive a new readiness activity item and store the new readiness activity item within the readiness knowledge-base.

11. The system of claim 1, wherein the team members comprise attributes indicating affiliation to one or more independent corporate entities.

12. The system of claim 1, wherein the responsibility matrix comprises a prioritization of the relevant readiness activities.
